(19) United States
(12) Patent Application Publication
(10) Pub. No.: US 2016/0347589 A1
(43) Pub. Date: Dec. 1, 2016

(54) CRANE SOCKET FOR A LOADING CRANE

(71) Applicant: Palfinger AG, Salzburg (AT)

(72) Inventor: Eckhard WIMMER, Hallein (AT)

(21) Appl. No.: 15/235,459

(22) Filed: Aug. 12, 2016

Related U.S. Application Data
(63) Continuation of application No. PCT/AT2015/000019, filed on Feb. 9, 2015.

(30) Foreign Application Priority Data
Feb. 14, 2014 (AT) GM 66/2014

(51) Int. Cl. B66C 23/44

(52) U.S. Cl. CPC B66C 23/44

(57) ABSTRACT

The invention relates to a crane socket for a loading crane, comprising a base part which has a bearing region for bearing the rotatable part of a loading crane, at least one support part which is used to additionally support the crane socket on a substructure, and a joint which connects the base part to the at least one support part, said joint being designed in the form of a torsionally flexible support, wherein one end of the support is connected to the base part, and the other end of the support is connected to the at least one support part.

The present invention concerns a crane base for a loading crane having the features of the classifying portion of claim 1 and a loading crane having the features of claim 3 and a motor vehicle having such a loading crane.

Crane bases are arranged in the central region of the non-rotatable part of a loading crane. Arranged in a base part (generally in the form of a transverse beam member) of the crane base is a mounting region for the rotating part of the loading crane. The mounting arrangement for the rotating part of the loading crane is generally implemented with two vertically offset displaced radial bearings and an upwardly or downwardly disposed thrust bearing (generally plain bearings). The slewing drive (for example: a toothed rack slewing drive) for the rotatable part of the loading crane is generally also disposed in or on the base part.

The crane base is also the connecting element in relation to the substructure (generally of a motor vehicle, for example a truck) and is fixed (generally by way of outwardly disposed plate members by screws) to the substructure by way of at least one support portion (generally a so-called “auxiliary frame”), by way of a fixing region.

The substructure, that is to say for example the truck chassis, is not to be inadmissibly deformed or stressed by the loading crane or the crane base which is fitted in place by way of the base part and the at least one support portion.

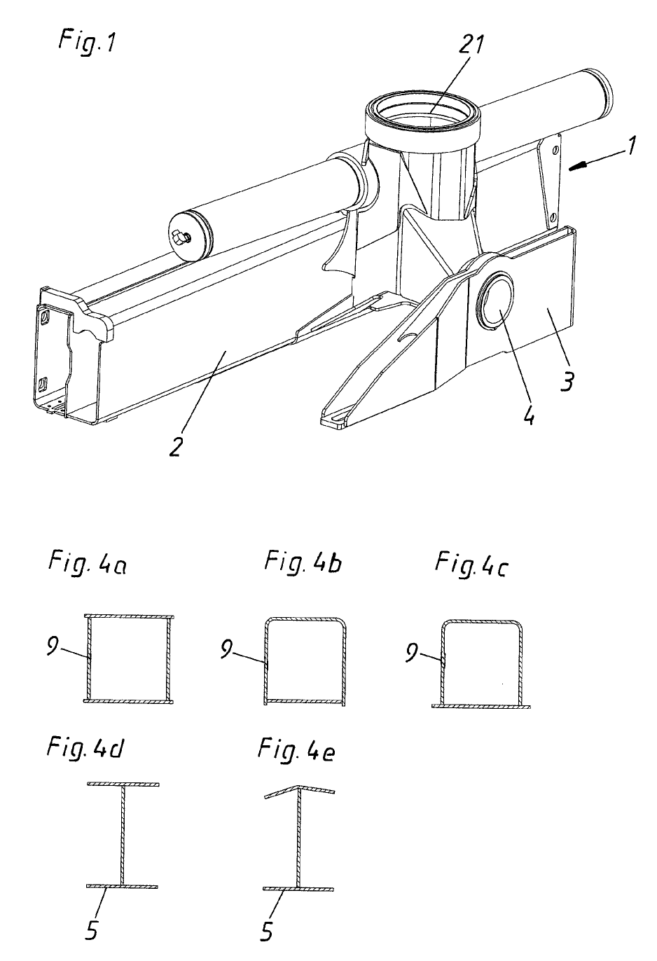

To achieve a statically determinate application of force, a journal pin is arranged between the base part and the at least one support portion (see FIG. 1). The at least one support portion which is mounted by way of a round mounting pin (“rocker pin”) is frequently referred to as the “rocker” and has a horizontal axis.

The carrier for the mounting pin is of a closed (torsionally stiff) cross-sectional shape. Both the base part and also the rocker are rigidly connected to the auxiliary frame substructure, but can rotate relative to each other about the horizontal axis (rocker axis). As a result the system is statically determinate.

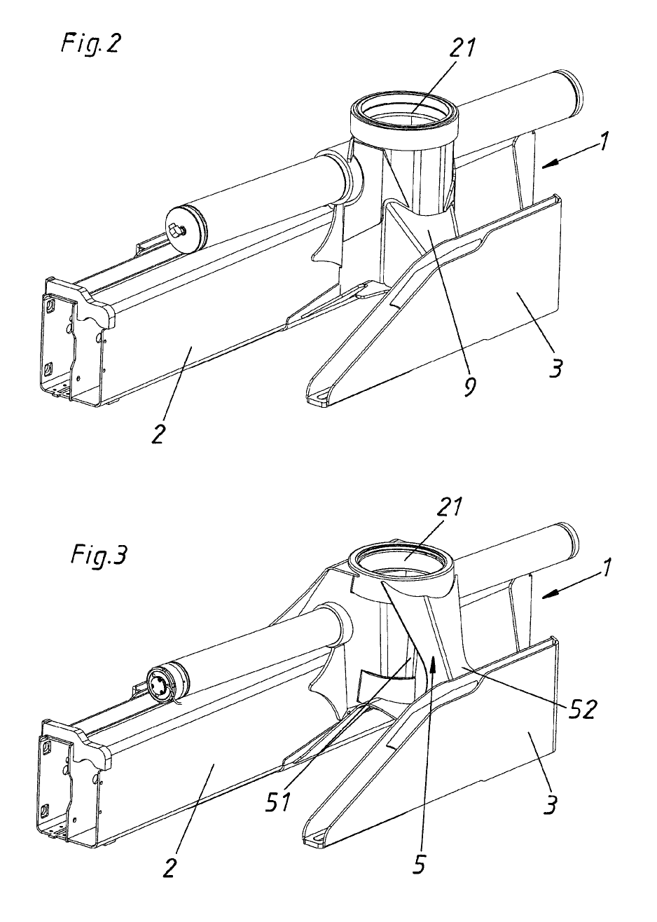

Another known form of construction is a rigid, one-piece structure for the crane base without the above-described rotary joint (FIG. 2). The profile shape of the carrier between the base part and the at least one support portion in relation to the substructure is usually implemented with a closed (torsionally stiff) box cross-section.

As the application of force to the at least one support portion and by way of same to the substructure is in that case statically indeterminate the substructure can be inadmissibly stressed.

The removal of the rotary joint means that this structure is admittedly simpler and less expensive, but is in particular often not desired by the manufacturers of motor vehicles.

The object of the invention is to provide a crane base, a loading crane and a motor vehicle having a loading crane, which are indeed statically determinate but which are simpler and less expensive to produce than the above-discussed structure using a rotary joint.

That object is attained by a crane base having the features of claim 1, a loading crane having the features of claim 3 and a motor vehicle having the features of claim 4.

The invention does not provide an additional journal pin joint between the base part and at least one support portion. By way of the torsionally flexible carrier which can be integrated into the steel construction of the crane base, the joint function is implemented even without the journal pin joint of the state of the art.

That can be effected for example by way of an open carrier structure (for example of a “I-profile structural configuration”) in the region in which the journal pin joint would usually be disposed. An open I-profile cross-section of suitable length is distinguished by a low level of torsional or rotational stiffness, but high flexural stiffness. The slight rotational movements which occur can therefore be passed by way of the carrier without same being thereby statically overloaded (by torsion). The transmission of all other forces or moments in operation of the crane is unrestrictedly possible. The function of such a structure is practically identical to that with “rocker pins”, but can be produced with a lower level of complication and expenditure.

Further details of the state of the art and of the invention can be seen in the Figures in which:

FIG. 1 shows a first solution according to the state of the art with a rotary joint,

FIG. 2 shows a second solution according to the state of the art, which is statically indeterminate,

FIG. 3 shows an embodiment of the invention,

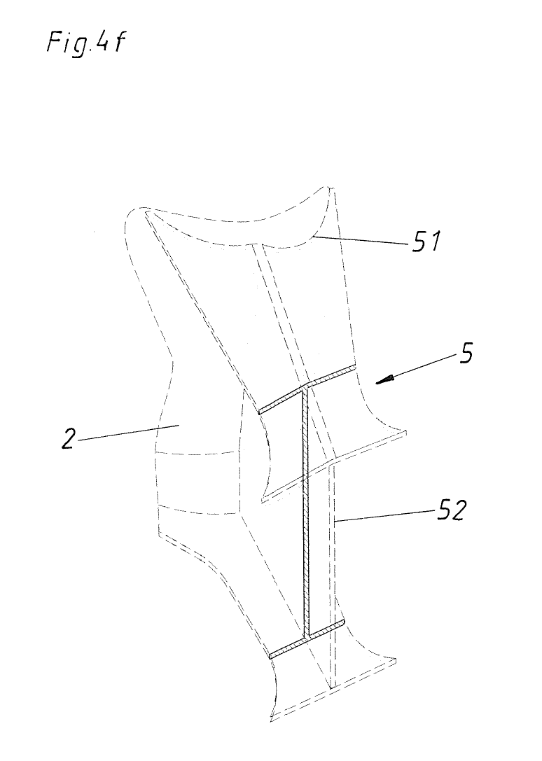

FIGS. 4a-4c show profile cross-sections according to the state of the art,

FIGS. 4d and 4e show profile cross-sections according to the invention,

FIG. 4f shows a perspective view of the carrier belonging to the profile cross-section shown in FIG. 4e, and

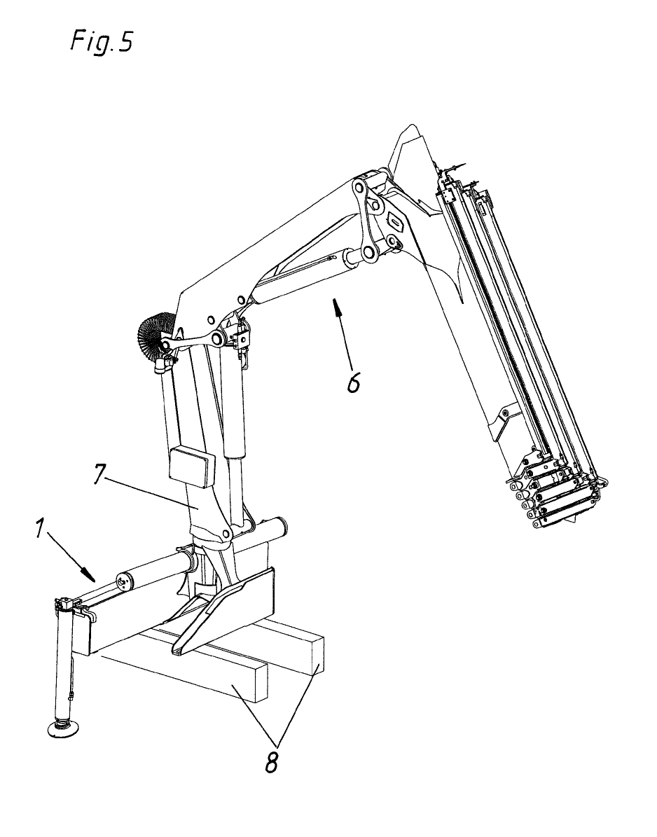

FIG. 5 shows a perspective view of a loading crane according to the invention together with substructure.

FIG. 1 shows a crane base 1 of the general kind set forth, in accordance with the state of the art, having a journal pin joint 4 between the base part 2 and the at least one support portion 3.

FIG. 2 shows a crane base 1 in accordance with the state of the art but not of the general kind set forth, in which the carrier 9 between the base part 2 and the at least one support portion 3 is torsionally stiff. Known profile cross-sections of known torsionally stiff carriers 9 are shown in FIGS. 4a through 4c.

FIG. 3 shows an embodiment of a crane base 1 according to the invention. The base part 2 has a mounting region 21 for mounting the rotating part 7 of a loading crane 6 (see FIG. 5). The base part 2 and the at least one support portion 3 are connected by way of a joint in the form of a torsionally flexible carrier 5 (see FIG. 4f), wherein the one end 51 of the carrier 5 is connected to the base part 2 and the other end 52 of the carrier 5 is connected to the at least one support portion 3. There is no rotary joint between the base part 2 and at least one support portion 3. The necessary rotatability of the base part 2 and at least one support portion 3 is afforded solely by the torsionally flexible carrier 5.

The profile cross-section belonging to that carrier 5 is shown in FIG. 4d. FIG. 4e shows an alternative. Independently of the form of the profile cross-section (here an “I-profile”) the open configuration of the carrier 5 is important as the torsional flexibility is afforded thereby.

1. A crane base for a loading crane comprising:
a base part having a mounting region for mounting the rotating part of a loading crane,
at least one support portion for additionally supporting the crane base on a substructure, and
a joint which connects the base part and the at least one support portion together,
wherein the joint is in the form of a torsionally flexible carrier, wherein the one end of the carrier is connected to the base part and the other end of the carrier is connected to the at least one support portion.

2. A crane base as set forth in claim 1, wherein the carrier is in the form of a profile having an open profile cross-section.

3. A loading crane having a crane base as set forth in claim 1.

4. A motor vehicle having a substructure to which a crane base as set forth in claim 1 is fixed.

5. A motor vehicle having a substructure to which a crane base as set forth in claim 2 is fixed.

6. A motor vehicle having a substructure to which a loading crane as set forth in claim 3 is fixed.

7. A loading crane having a crane base as set forth in claim 2.

8. A crane base as set forth in claim 2, wherein the carrier has an I-profile cross-section.
